(19) United States
(12) Patent Application Publication
(10) Pub. No.: US 2006/0092078 A1
(43) Pub. Date: May 4, 2006

(54) Antenna systems for widely-spaced frequency bands of wireless communication networks

(75) Inventor: Gary George Sanford, Camarillo, CA (US)

Correspondence Address: KOPPEL, PATRICK & HEYBL, 555 ST. CHARLES DRIVE, SUITE 107, THOUSAND OAKS, CA, 91360, US

(73) Assignee: CALAMP CORPORATE

(21) Appl. No.: 11/050,030

(22) Filed: Feb. 2, 2005

Related U.S. Application Data
(60) Provisional application No. 60/624,684, filed on Nov. 2, 2004.

(51) Int. Cl. H01Q 9/04; H01Q 21/00

(52) U.S. Cl. 343/700 MS; 343/853

(57) ABSTRACT

Antenna system embodiments are provided for operation over widely-spaced communication bands. The systems include second antennas circumferentially interleaved with first antennas about a system axis. In embodiments, the first antennas are formed with beam-shaping members that enhance performance of cavity-backed slots and the second antennas provide arrays of outer patches that are excited by inner patches. The first and second patches are arranged to have orthogonal polarization for enhanced isolation.

### CROSS REFERENCES TO RELATED APPLICATIONS

This application claims the benefit of U.S. Provisional Application Ser. No. 60/624,684 filed Nov. 2, 2004.

### BACKGROUND OF THE INVENTION

1. Field of the Invention

The present invention relates generally to antenna systems.

2. Description of the Related Art

Modern communication standards have been developed to control wireless communications over widely-spaced frequency bands. Examples are the 802.11 and 802.16 standards of the Institute of Electrical and Electronics Engineers (IEEE) that concern wireless communication in metropolitan area networks. Commonly referred to as WiFi (wireless fidelity) and WiMAX (worldwide interoperability for microwave access), these standards are intended to facilitate wireless networks that provide various communication services.

To make full use of these standards, communication networks must be capable of simultaneously operating in communication bands that have significantly different wavelengths (e.g., first and second wavelengths wherein the first wavelength is at least twice the second wavelength). This is a demanding requirement which current antenna systems generally fail to meet.

### BRIEF SUMMARY OF THE INVENTION

The present invention provides antenna system embodiments that are configured for efficient performance over widely-spaced frequency bands. The novel features of the invention are set forth with particularity in the appended claims. The invention will be best understood from the following description when read in conjunction with the accompanying drawings.

### BRIEF DESCRIPTION OF THE DRAWINGS

FIG. 1 is a isometric view of an antenna system embodiment of the present invention;

FIG. 2 is a side view of the system of FIG. 1;

FIG. 3 is a view along the plane 3-3 of FIG. 2;

FIG. 4 is top view of the system of FIG. 1;

FIG. 5 is a view of a microstrip feed structure in the system of FIG. 1;

FIG. 6A includes front, side, back and end views of a first antenna in the system of FIG. 1;

FIG. 6B is an isometric view of the first antenna of FIG. 6A;

FIG. 7A includes sectioned, front, side, back and end views of a second antenna in the system of FIG. 1;

FIG. 7B is an isometric view of the second antenna of FIG. 7A; and

FIG. 8 is a Smith chart that illustrates impedance matches in feed lines of the second antenna of FIGS. 7A and 7B.

### DETAILED DESCRIPTION OF THE INVENTION

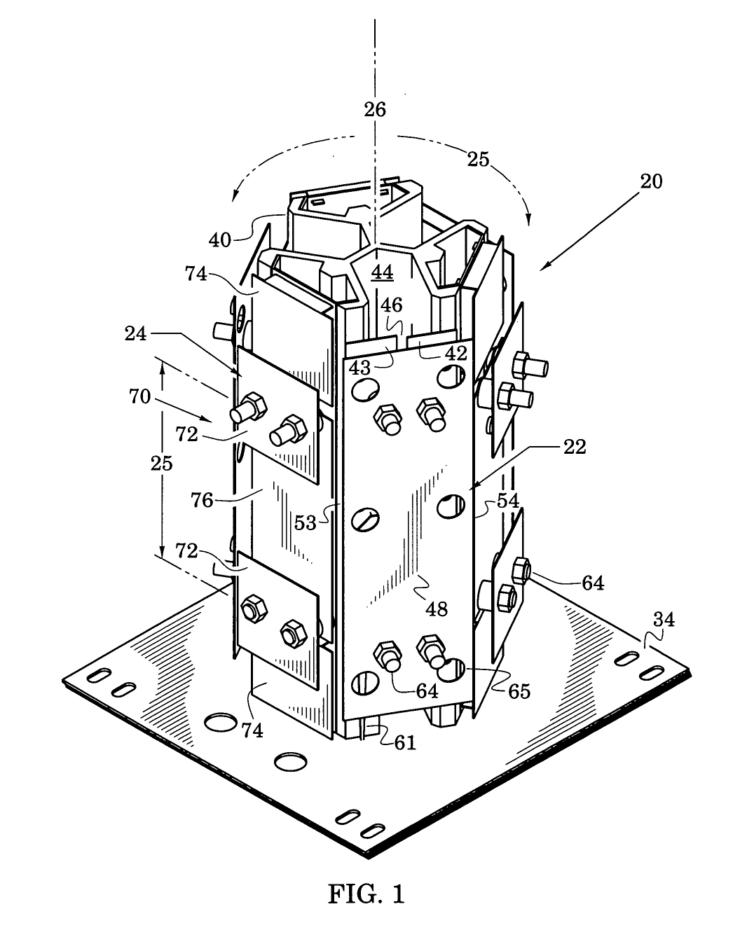

FIGS. 1-8 illustrate antenna system embodiments which enhance antenna performance when radiating and receiving signals of widely-spaced frequency bands having significantly different signal wavelengths.

As particularly shown in FIGS. 1-5, an antenna system embodiment 20 includes first antennas 22 that are configured to radiate and receive signals having a first polarization. The system also includes second antennas 24 that are configured to radiate and receive signals having a second polarization that differs from the first polarization by a polarization difference.

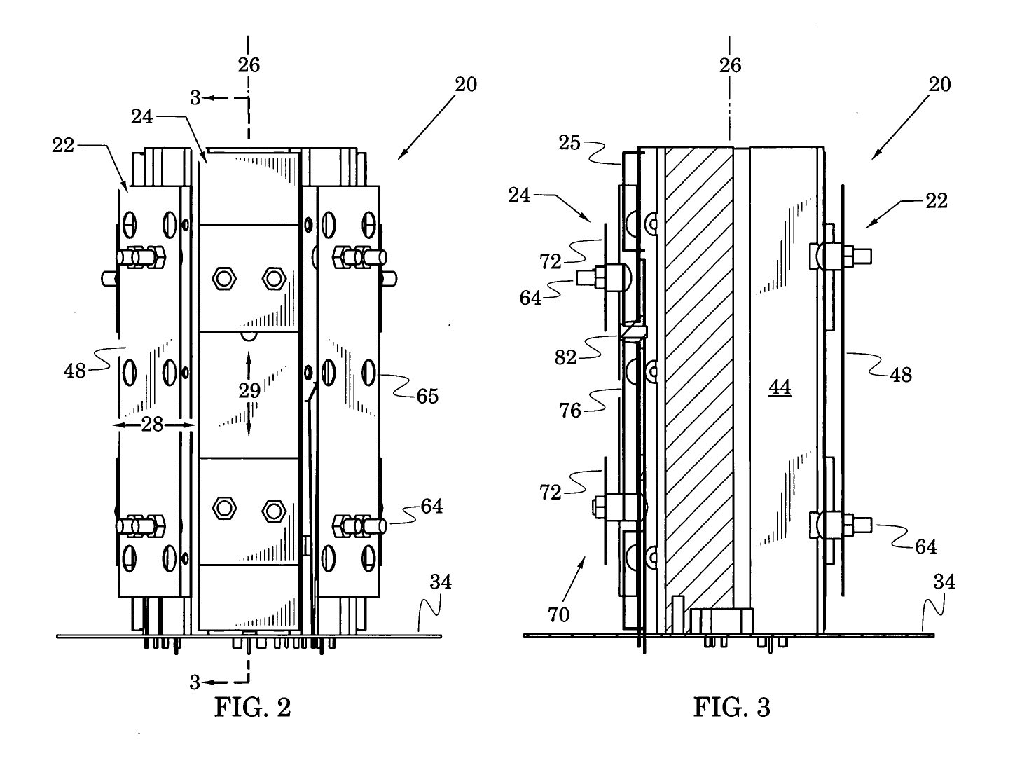

Although different system embodiments can be realized with different polarization relationships, the relationship is preferably an orthogonal one to enhance signal isolation. Although different system embodiments can be realized with different polarizations (e.g., elliptical), the polarizations of the embodiment 20 are linear with a polarization difference that is substantially 90 degrees (i.e., they are orthogonally related). For descriptive simplicity, the structure of the first and second antennas may subsequently be said to “have a first polarization” and “have a second polarization” which are respectively shown by arrows 28 and 29 in FIG. 2.

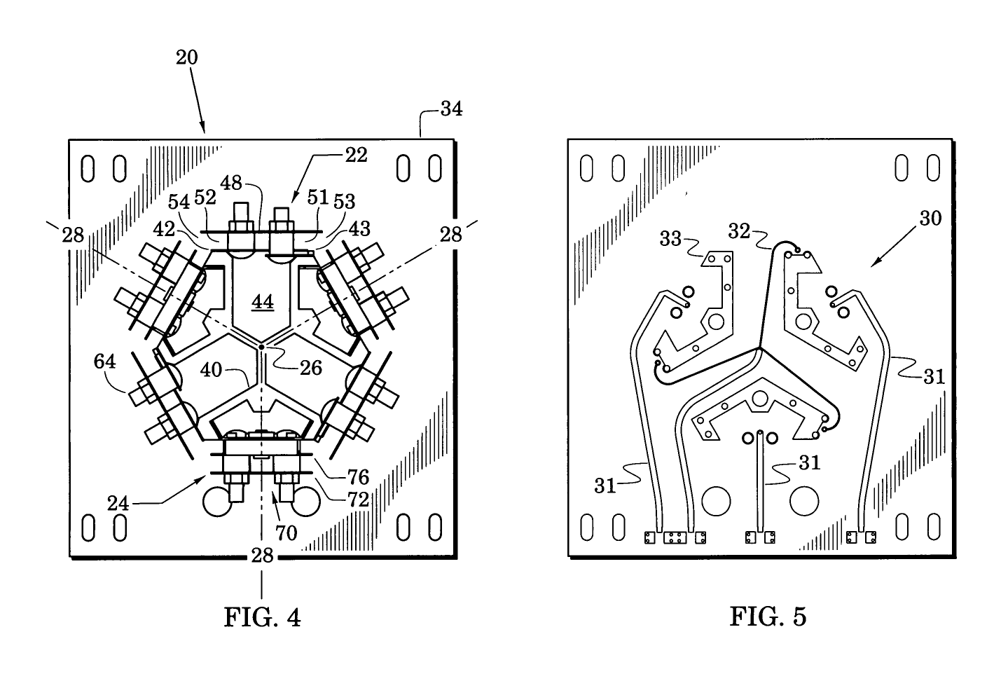

In the system 20, the second antennas 24 are circumferentially interleaved with the first antennas about a system axis 26 that is shown in FIGS. 1 and 4 (circumferential arrow 25 indicates circumferential direction in FIG. 1). Because this arrangement places each antenna between antennas having a different polarization, radiation and reception processes of each antenna are effectively isolated from similar processes of adjoining antennas.

The circumferentially-interleaved arrangement also facilitates various operational modes of the system. In an exemplary operational mode, each of similar antennas (e.g., the second antennas 24) can be selected for signal radiation and reception in antenna beams directed along a respective one of the beam axes 28 shown extending outward from the system axis 26 in FIG. 4. In another exemplary operational mode, similar antennas (e.g., the first antennas 22) can be commonly selected for signal radiation and reception in a common omnidirectional beam oriented about the system axis 26.

The first exemplary mode is facilitated with the microstrip feed structure 30 of FIG. 5 which includes feed lines 31 that each connect to a respective one of the second antennas 24. The second exemplary mode is facilitated with microstrip feed lines 32 which connect to all of the first antennas 22. Additional conductive elements 33 provide grounding contact for the conductive member 40 of FIG. 1. It is noted that FIGS. 1-4 show a system mounting plate 34 and that the feed structure 30 of FIG. 5 is carried by the mounting plate (FIG. 5 is viewed from the same perspective as is FIG. 4). The system 20 is thus suited for signal exchanges with selected ones of a group of communication stations via the second antennas 24 and for simultaneous signal exchanges with all stations via the first antennas 22.

Although various antenna structures can be used in different embodiments of the system 20, an exemplary first antenna embodiment includes a beam-shaping member and at least one conductive member which defines a cavity and also defines a slot that communicates with the cavity.

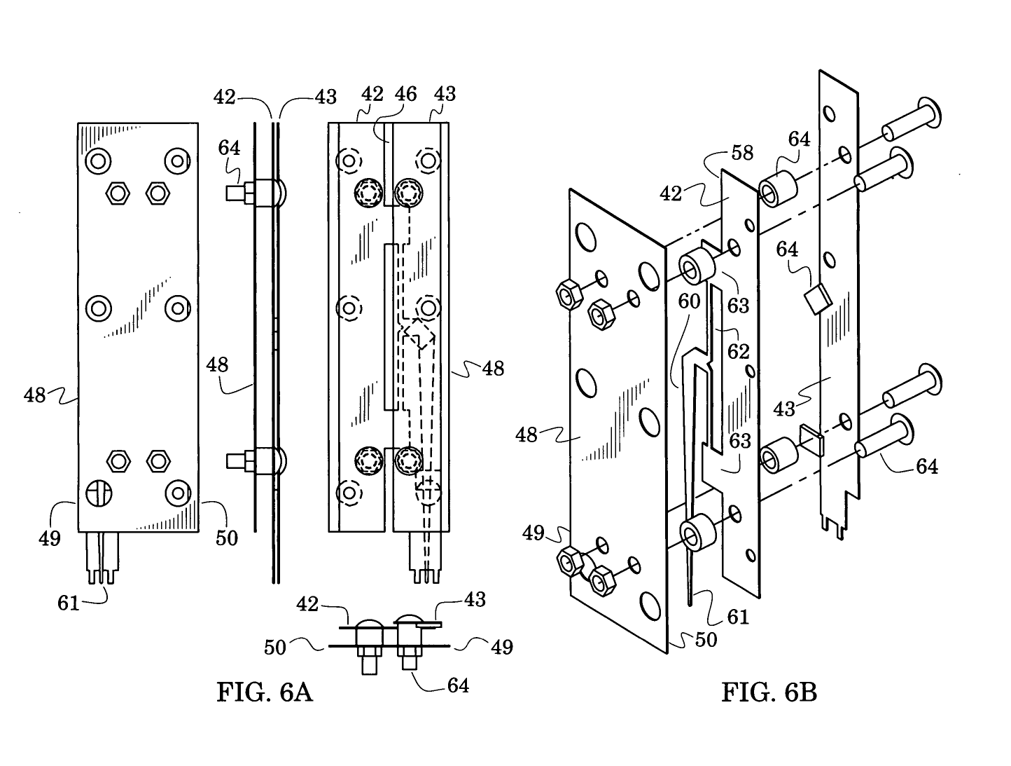

Before describing this antenna embodiment further, it is noted that a conductive member 40 is shown in FIG. 1 and that FIGS. 6A and 6B show additional conductive members 42 and 43. Although the conductive members 40, 42 and 43 are configured as separate elements to facilitate fabrication and assembly, conceptually they may also be considered to be a single conductive member and, accordingly, they are sometimes described as such in the following description. In one system embodiment, for example, conductive members 42 and 43 are attached to conductive member 40 with screws (not shown). The conductive member 40 serves several purposes of which one is to support the various system elements.

A cavity 44 is particularly shown in FIGS. 1 and 4 and FIGS. 1, 6A and 6B show additional structures of the first antenna embodiment. As explained above, at least one conductive member in these figures defines a cavity 44 and a slot 46 that communicates (i.e., electromagnetically couples) with the cavity. A beam-shaping member 48 is also provided and the slot is positioned between the cavity 44 and its associated beam-shaping member.

The beam-shaping member 48 is preferably a planar member that extends between first and second edges 49 and 50. As best seen in FIG. 4, the beam-shaping member is spaced from the slot (46 in FIGS. 1 and 6A) to form, with the conductive members 42 and 43, first and second passages 51 and 52 that begin at the slot and are directed oppositely to terminate in first and second elongated apertures 53 and 54 at the first and second edges (49 and 50 in FIG. 6A).

As shown in FIG. 6B, the conductive member 42 defines one edge 58 of the slot 46 and also defines a feed line 60 which couples to the edge. Preferably, the feed line begins at a tip 61 and divides into two feed branches 62 which form a power splitter that couples to the edge 58 at spaced feed points 63. The tip 61 is received into one of the feed lines 32 of FIG. 5. In different system embodiments, reactive elements may be incorporated into the feed line to enhance its dual-band performance. Various pieces of assembly hardware 64 secure parts of the system together and this hardware is formed with materials (e.g., polymers) that are substantially electromagnetically transparent. This assembly hardware includes spacers used for sufficiently spacing conductive member 42 from member 43 to provide space for the feed line 60. Access holes 65 are also provided to facilitate assembly of the antenna system.

In a radiating mode of each of the first antennas 22, electrical power is coupled along feed lines 32 in FIG. 5 and then along feed line 60 in FIG. 6B to spaced feed points 63 which excite the slot 46. The cavity 44 helps to direct power from the slot (46 in FIG. 1). The power splits and travels oppositely through the passages 51 and 52 to radiate from the elongate apertures 53 and 54 as best seen in FIG. 4. The elongate apertures are also indicated in FIG. 1.

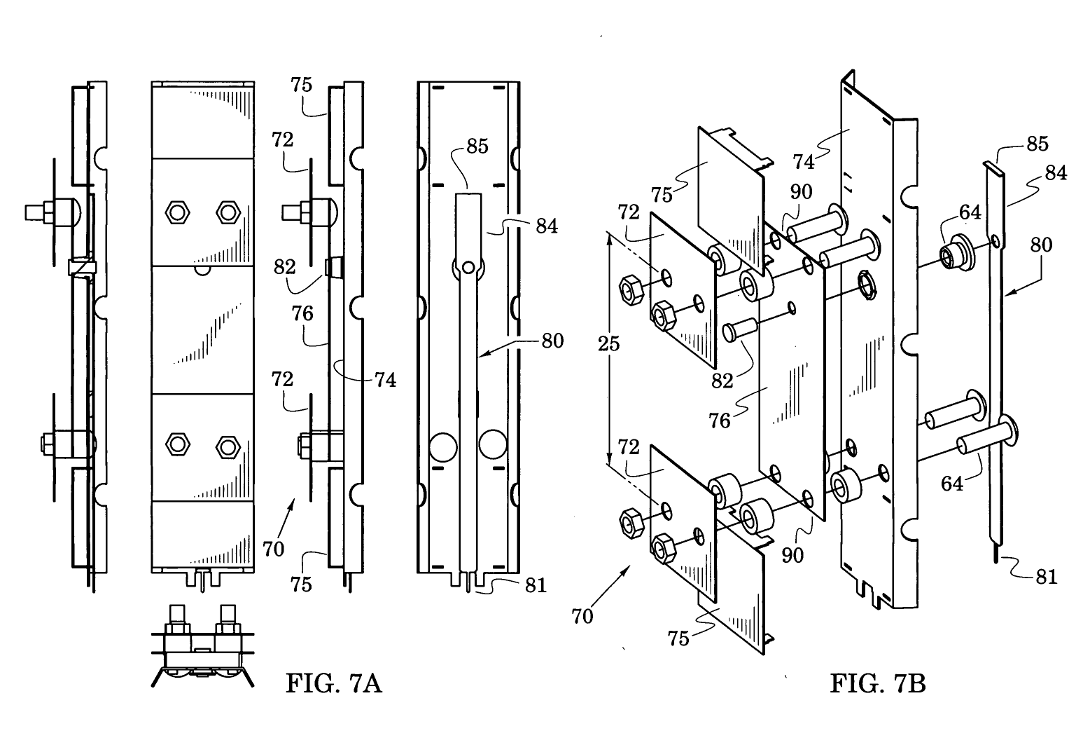

It was stated above that the system 20 includes second antennas 24 which are circumferentially interleaved with first antennas 22 about a system axis 26 and that various antenna structures can be used in different embodiments of the system. An exemplary second antenna embodiment is particularly shown in FIGS. 7A and 7B to include an array 70 of at least two outer patches 72, a ground plane 74, and an inner patch 76 that is spaced between the array and the ground plane.

In addition, a feed line 80 begins at a tip 81 and couples to the inner patch 76 via a probe 82 that passes through the ground plane 74. The tip 81 is received into one of the feed lines 31 of FIG. 5. The feed line includes a resonant circuit in the form of a transmission line 84 that is shorted to the ground plane at one end 85. The susceptance of this resonant circuit adds to the susceptance of the probe to thereby alter the total impedance seen by the feed line 80.

The ground plane of the second antenna actually comprises more than one element. A first is the ground plane 74 referenced above and a second and third are additional ground plane segments 75 which are stepped above the ground plane 74 so that they are substantially coplanar with the inner patch 76. As noted above with reference to the first antenna, various pieces of electromagnetically-transparent assembly hardware 64 are used to secure parts of the second antennas.

Antenna system embodiments of the invention are especially suited for operation in widely spaced frequency bands of wireless communication networks. As mentioned in the background, 802.11 and 802.16 standards were developed by the Institute of Electrical and Electronics Engineers (IEEE) for wireless communication in metropolitan area networks. These networks are often referred to respectively as WiFi and WiMAX and are intended to provide “the last 100 yards” and “the last mile” in wireless communication networks that connect remote locations (e.g., homes, businesses and local area networks (LANs)) to communication services (e.g., the internet).

These networks use widely-spaced communication bands such as the Industrial, Science and Medicine (ISM) bands and the Unlicensed National Information Infrastructure (UNII) bands which approximately cover the 2.4-2.5 GHz and 5.2-5.8 GHz regions. Accordingly, communication systems for these standards must be able to operate with signals having first and second wavelengths in which the first wavelength is at least twice the second wavelength.

Antenna system embodiments of the invention are particularly suited to meet these needs and can be installed, for example, in various rooms of a large building to serve as wireless access points which enable wireless communications within and between the rooms. In this application, the first antennas 22 that are particularly shown in FIGS. 4, 6A and 6B can effectively form omnidirectional antenna beams at the first and second wavelengths. These omnidirectional beams can be used for various communication purposes such as sending “broadcast” messages to other stations in a communication network. For reference purposes, it is noted that an antenna system embodiment configured for this application has a height (in FIG. 1) of approximately 9.7 centimeters.

The second antennas 24 (particularly shown in FIGS. 4, 7A and 7B) can be dimensioned so that they generate 3 beams which can each cover ⅓ of a complete azimuth circumference to thereby enable communication with selected ones of all communication stations of the network. Each of the second antennas can thus support data and voice traffic with respective ones of the stations.

When the first antenna 22 (particularly shown in FIGS. 4, 6A and 6B) operates at these first and second wavelengths, it applies an electric field across the slot 46 at spaced feed points 63. The slot length is selected to be somewhat less than a wavelength at the longer first wavelength. Because the slot length is greater than a wavelength at the shorter second wavelength, the feed line 60 is coupled to the slot at spaced feed points 63 so that this spacing effectively controls excitation modes at the shorter second wavelength. It has been found that the slot ends can be left open as shown in the figures or can be closed in other embodiments.

Signals at both the longer and shorter wavelengths excite an electric field across the slot 46 and this flow of power is directed outward by the cavity 44. The beam-shaping member 48 causes this power to be split and directed oppositely through the passages 51 and 52 to radiate from the elongate apertures 53 and 54 as best seen in FIG. 4. This power splitting and guiding process sufficiently shapes the azimuth beam pattern of each of the first antennas so that together they generate an omnidirectional torus-shaped beam.

The lengths of the cavity, slot and beam-shaping member are selected to shape the omnidirectional beam with elevation beamwidths on the order of 50° and 30° for signals respectively having the first and second wavelengths. The width (between edges 49 and 50) of the beam-shaping member 48 may be selected to realize the desired azimuthal beam shaping. Although the array 70 includes two outer patches in the illustrated embodiment, other system embodiments may use different arrays with different number of outer patches.

When the second antenna 24 (particularly shown in FIGS. 4, 7A and 7B) operates at these first and second wavelengths, the inner patch 76 has a resonant length that can be selected to be somewhat shorter than ½ of the first wavelength (to account for various modifying effects, e.g., fringing effects and the loading of the outer patches 72). Signals at the first wavelength are applied to the probe 82 to excite currents on the inner patch. The probe 82 is attached (e.g., by solder) to a horizontally-centered point near one end of the inner patch so as to induce the second polarization (29 in FIG. 2) Although a probe is used in this embodiment, others may use different coupling arrangements (e.g., capacitive coupling).

Via the inner patch 76, a signal at the second wavelength excites the outer patches 72 of the array 70 and they generate a beam with the same polarization (29 in FIG. 2). At the shorter second wavelength, the long inner patch 76 acts as a transmission line over the ground plane 74. It couples power to the outer patches 72 to produce an electric field between each outer patch and conductive surfaces immediately below it. Because the stepped ground plane segments 75 are positioned substantially coplanar with the inner patch 76, they and the inner patch form a continuous ground plane for the array 70 at the second wavelength.

The outer patches 72 each have a resonant length that is selected to be somewhat shorter than ½ of the second wavelength and the array 70 has an array spacing (25 in FIGS. 1 and 7B) which is selected to be somewhat less than the second wavelength to avoid the formation of grating lobes. Generally, the array spacing is greater than ½ of the second wavelength and the outer patches of the array 70 are positioned over the ends (90 in FIG. 7B) of the inner patch 76. The array 70 thus realizes a radiating aperture on the order of, or greater than, the radiating aperture of the inner patch 76 which significantly enhances gain for signals of the shorter second wavelength.

The second antenna 24 can typically generate beams with elevation beamwidths on the order of 50° and 30° at the first and second wavelengths respectively. The widths of the inner patch 76 and the outer patches 72 can be selected to alter the azimuth beam width of the second antennas 24. In one embodiment, the second antenna 25 was configured to generate beams with azimuth beamwidths on the order of 100°.

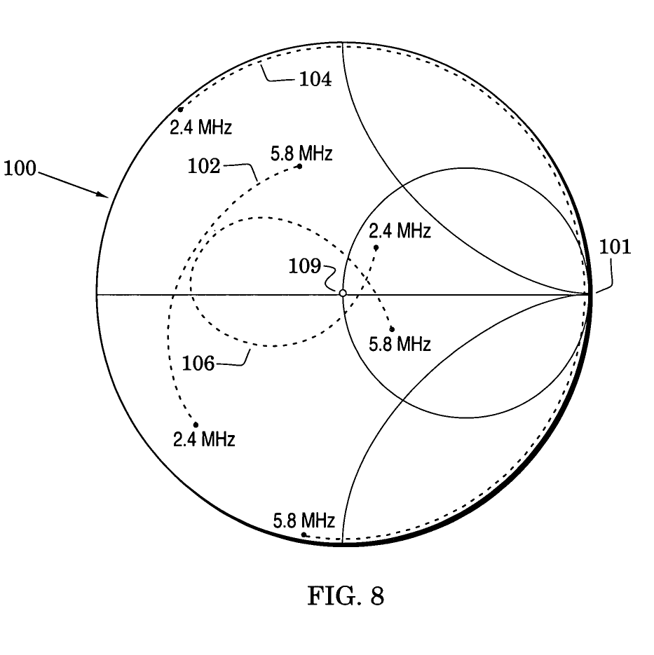

The length of the shorted transmission line 84 is chosen to present a selected susceptance to the feed line 80 at its intersection with the probe 82. This susceptance is selected to combine in parallel with the impedance presented to the probe by the inner patch 76 and array 70. It is selected so that the combined impedance substantially matches the feed line impedance of the feed line 80 at the first and second wavelengths as shown in the Smith chart 100 of FIG. 8.

The Smith chart 100 has a high impedance point 101 and includes an impedance plot 102 that shows the impedance at an exemplary probe (82 in FIG. 7B) over the frequency range of 2.4-5.8 GHz. Another impedance plot 104 shows the impedance of the shorted line (84 in FIG. 7B) over the same frequency range. The impedance plot 106 circles the impedance of the feed line 50 (e.g., 50 ohms) and shows the impedance over the frequency range of 2.4-5.8 GHz when the impedances of the probe and shorted line are combined in parallel. It is noted that the impedance 106 is sufficiently close to the 50 ohm point 109 for signals at the first and second wavelengths (i.e., for signal frequencies of 5.8 and 2.4 GHz).

Antenna system embodiments of the invention thus provide a number of advantageous features for operation over widely-spaced communication bands. They include but are not limited to a) second antennas circumferentially interleaved with first antennas about a system axis to enhance isolation and station coverage, b) beam-shaping members that shape beams associated with cavity-backed slots, c) feed lines shaped to control modes in cavity-backed slots at a shorter second wavelength, d) patch arrays excited by respective inner patches and arranged to provide large radiating apertures at shorter second wavelengths, e) ground plane segments positioned coplanar with inner patches to form ground planes for arrays of outer patches at shorter second wavelengths, and f) shorted transmission lines used to enhance feed line impedance matches at first and second wavelengths.

For clarity of description, antenna embodiments have been described above with reference sometimes to a radiation process and sometimes to a reception process. Because reciprocity is an inherent characteristic of antennas, these descriptions also apply to the other of the radiation and reception processes.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

I claim:

1. An antenna, comprising:
a beam-shaping member; and
at least one conductive member that defines a cavity and defines a slot which communicates with said cavity and is positioned between said cavity and said beam-shaping member.

2. The antenna of claim 1, wherein said beam-shaping member is spaced from said slot to form, with said conductive member, first and second passages that join at said slot.

3. The antenna of claim 2, wherein said beam-shaping member is a planar member that terminates in first and second sides positioned oppositely from said slot so that said first and second passages extend oppositely from said slot and respectively terminate in first and second apertures at said first and second sides.

4. The antenna of claim 1, wherein said slot is defined by at least first and second spaced edges of said conductive member and futher including a feed line that couples to one of said edges.

5. The antenna of claim 4, wherein said feed line is configured to couple to one of said edges at first and second spaced feed points.

6. The antenna of claim 4, wherein said feedline is defined by said conductive member.

7. The antenna of claim 1, wherein said first and second edges are spaced differently from said cavity to facilitate coupling of said feedline to one of said edges.

8. The antenna of claim 1, wherein said cavity and said slot each terminate in at least one open end.

9. An antenna system, comprising:
beam-shaping members; and
at least one conductive member that defines cavities circumferentially spaced about a system axis and defines slots that each communicates with a respective one of said cavities and is positioned between its respective cavity and a respective one of said beam-shaping members.

10. The system of claim 9, wherein each of said beam-shaping members is spaced from its respective slot to form, with said conductive member, first and second passages that join at that respective slot.

11. The system of claim 10, wherein each of said beam-shaping members is a planar member that terminates in first and second sides positioned oppositely from its respective slot so that said first and second passages extend from that slot and respectively terminate in first and second apertures at said first and second sides.

12. The system of claim 10, wherein each of said slots is defined by at least first and second spaced edges of said conductive member and futher including a common feed structure which defines feed lines that each couple to an edge of a respective one of said slots.

13. The system of claim 12, wherein each of said feed lines is configured to couple to its respective edge at first and second spaced feed points.

14. The system of claim 9, wherein said cavity and said slots all terminate in at least one open end.

15. The system of claim 9, wherein the number of cavities is three and they are equally spaced about said system axis.

16. An antenna, comprising:
an array of at least two outer patches;
a ground plane;
an inner patch spaced between said array and said ground plane; and
a feed structure coupled to said inner patch to permit feed signals to electromagnetically excite said inner patch and said array.

17. The antenna of claim 16, wherein said inner patch terminates in first and second ends and said array has an array spacing such that each of said ends lies beneath a respective one of said outer patches.

18. The antenna of claim 16, wherein said inner patch is dimensioned to be resonant at a first signal wavelength, said outer patches are dimensioned to be resonant at a shorter second signal wavelength, and said array has an array spacing that is less than said second signal wavelength.

19. The antenna of claim 18, wherein array spacing is at least one half of said second signal wavelength.

20. The antenna of claim 18, wherein said ground plane includes:
an inner segment spaced from said inner patch; and
an outer segment spaced from at least one of said outer patches to be substantially coplanar with said inner patch;
said outer segment and said inner patch providing a ground plane for said outer patch at said second signal wavelength.

21. The antenna of claim 16, wherein each of said outer patches has an outer area and said inner patch has an inner area greater than said outer area.

22. The antenna of claim 21, wherein said inner area is at least twice said outer area.

23. The antenna of claim 16, wherein said feed structure comprises a probe coupled to said inner patch.

24. The antenna of claim 23, wherein said inner patch terminates in first and second ends and said probe is coupled closer to one of said ends than to the other of said ends.

25. The antenna of claim 23, wherein said feed structure includes a resonant circuit arranged to alter the impedance of said probe.

26. The antenna of claim 16, wherein said ground plane is stepped to maintain substantially constant spacing from said array and said inner patch.

27. The antenna of claim 16, wherein said array is limited to two outer patches.

28. An antenna system, comprising:
first antennas having a first polarization; and
second antennas circumferentially interleaved with said first antennas about a system axis and having a second polarization that differs from said first polarization by a polarization difference.

29. The system of claim 28, wherein said polarization difference is substantially 90 degrees.

30. The system of claim 28, wherein each of said first antennas comprises:
a beam-shaping member; and
at least one conductive member that defines a cavity and a slot which communicates with said cavity, is positioned between said cavity and said beam-shaping member, and is substantially parallel to said second polarization.

31. The system of claim 30, wherein said beam-shaping member is spaced from said slot to form, with said conductive member, first and second passages that join at said slot.

32. The system of claim 31, wherein said beam-shaping member is a planar member that terminates in first and second sides positioned oppositely from said slot so that said first and second passages extend from said slot and respectively terminate in first and second apertures at said first and second sides.

33. The system of claim 30, wherein said slot is defined by at least first and second spaced edges of said conductive member and futher including a feed line that couples to one of said edges at first and second spaced feed points.

34. The system of claim 30, wherein said cavity and said slot each terminate in at least one open end.

35. The system of claim 30, wherein each of said second antennas comprises:
an array of at least two outer patches;
a ground plane;
an inner patch spaced between said array and said ground plane; and
a feed structure coupled to said inner patch to permit feed signals to electromagnetically excite said inner patch and said array with a polarization substantially orthogonal to said first polarization.

36. The system of claim 35, wherein said inner patch terminates in first and second ends and said array has an array spacing such that each of said ends lies beneath a respective one of said outer patches.

37. The system of claim 35, wherein said inner patch is dimensioned to be resonant at a first signal wavelength, said outer patches are dimensioned to be resonant at a shorter second signal wavelength, and said array has an array spacing that is less than said second signal wavelength.

38. The system of claim 35, wherein each of said outer patches has an outer area and said inner patch has a greater inner area.

39. The system of claim 35, wherein said inner patch terminates in first and second ends and said feed structure comprises a probe coupled closer to one of said ends than to the other of said ends.

40. The system of claim 39, wherein said feed structure includes a resonant circuit arranged to alter the impedance of said probe.
